(19) United States
(12) Patent Application Publication
(10) Pub. No.: US 2003/0066709 A1
(43) Pub. Date: Apr. 10, 2003

(54) Portable table

(76) Inventor: Lee Gordon Elliott, Edmonds, WA (US)

Correspondence Address: BLACK LOWE & GRAHAM PLLC, 816 Second Avenue, Seattle, WA, 98104, US

(21) Appl. No.: 10/238,845

(22) Filed: Sep. 10, 2002

Related U.S. Application Data
(60) Provisional application No. 60/322,212, filed on Sep. 10, 2001.

(51) Int. Cl. E06C 5/32

(52) U.S. Cl. 182/28; 182/129

(57) ABSTRACT

A portable table assembled with the use of an extension ladder that is located at the job site. The portable saw table is easily assembled from combining a plurality of component parts together and transforming an ordinary extension ladder into an accurate workstation for saw and carpentry tasks.

### PRIORITY CLAIM

This invention claims priority to the provisional application Serial No. 60/322,212 filed Sep. 10, 2001.

### FIELD OF THE INVENTION

This invention relates generally to a portable table and, more specifically, a portable carpenter's table.

### BACKGROUND OF THE INVENTION

Construction, of any type, is typically done in a dynamic environment. More specifically, most construction projects are subject to revision or modification during construction. Thus, the carpenters, or other construction persons, must have an ability to perform their job within the dynamic environment. Typical carpentry and other construction projects require an ability to fabricate construction elements at the job site. Often, the job site is at a remote location, or generally in an inconvenient location. There does not exist an inexpensive and reliable system for providing an elevated work surface at a remote site. There are portable tables on the market, but they are generally cumbersome, expensive and require additional equipment or tools at the job site.

Thus, there is a need for an inexpensive portable table that is reliable, accurate and easily integrated into the worker's stable of tools.

### SUMMARY OF THE INVENTION

A portable table is provided. The portable table includes a ladder and one or more table components. The one or more table components include a table surface piece and at least two legs coupled to the table surface piece. The legs are configured to be received by the ladder.

The table further includes at least two ladder support structures.

The legs are hingedly attached to the table surface piece.

The table further includes a pin connection device for coupling the legs to the top surface.

### BRIEF DESCRIPTION OF THE DRAWINGS

The preferred and alternative embodiments of the present invention are described in detail below with reference to the following drawings:

FIG. 1 is a diagram illustrating an exemplary portable table in accordance with the present invention;

FIG. 2 is a front view illustrating an exemplary portable table in accordance with the present invention;

FIGS. 3A-B are diagrams illustrating the exemplary components of a portable table in accordance with the present invention;

FIG. 3C is a side view diagram illustrating an exemplary portable table in accordance with the present invention; and

FIGS. 4 and 5 illustrate folding embodiments of the present invention.

### DETAILED DESCRIPTION OF THE PREFERRED EMBODIMENT

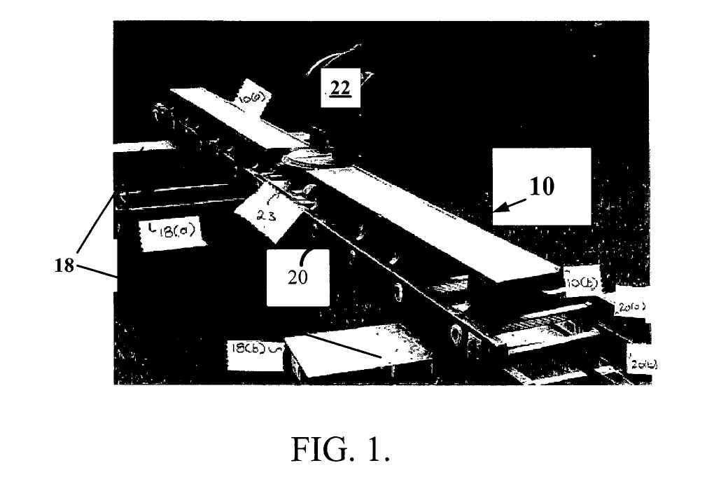

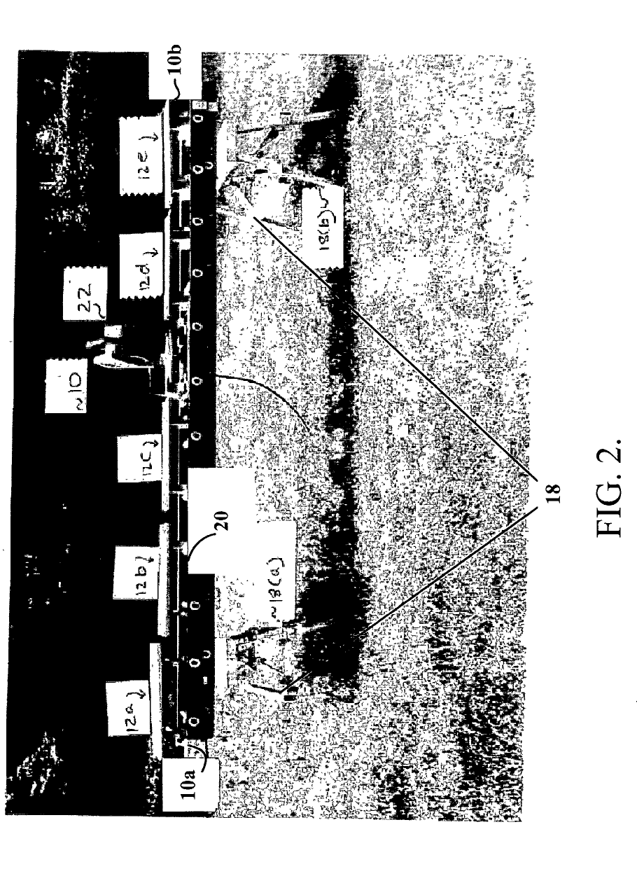

The present invention provides a portable table. In one embodiment, as shown in FIGS. 1 and 2, the present invention is a portable table 10 that includes a left half 10(a) and a right half 10(b), a tool 22, and a tool base 23 located between the respective halves. The table 10 connects with a ladder 20, such as an extension ladder. The ladder 20 rests upon or is secured to elevating elements 18, such as a pair of sawhorses 18(a,b). A left half 10(a) of the portable table 10 includes three component parts 12(a-c). The three component parts 12(a-c) are placed adjacent one another. A right half 10b of the portable table 10 includes two component parts 12(d,e) placed adjacent to each other. The portable table 10 is affixed to an outer section 20a of the ladder 20. The outer section 20a is slidably attached to an inner section 20b of the ladder 20. Alternatively, the portable table 10 is attached to the inner section of the ladder 20, wherein the inner section 20b is slidably attached to the outer section 20a. Moreover, while the diagrams illustrate using a miter saw, any other tool can also be used, such as a circular, rotor and table saws, drills, routers, edgers, sanders, mills, lathes, welders, or any other tool. In a preferred embodiment, the portable table is placed over a pair of sawhorses and is easily transformed to a working saw or carpenter's table at any job site. However, any structure can be used in place of the sawhorses, including placing the ladder directly on the ground.

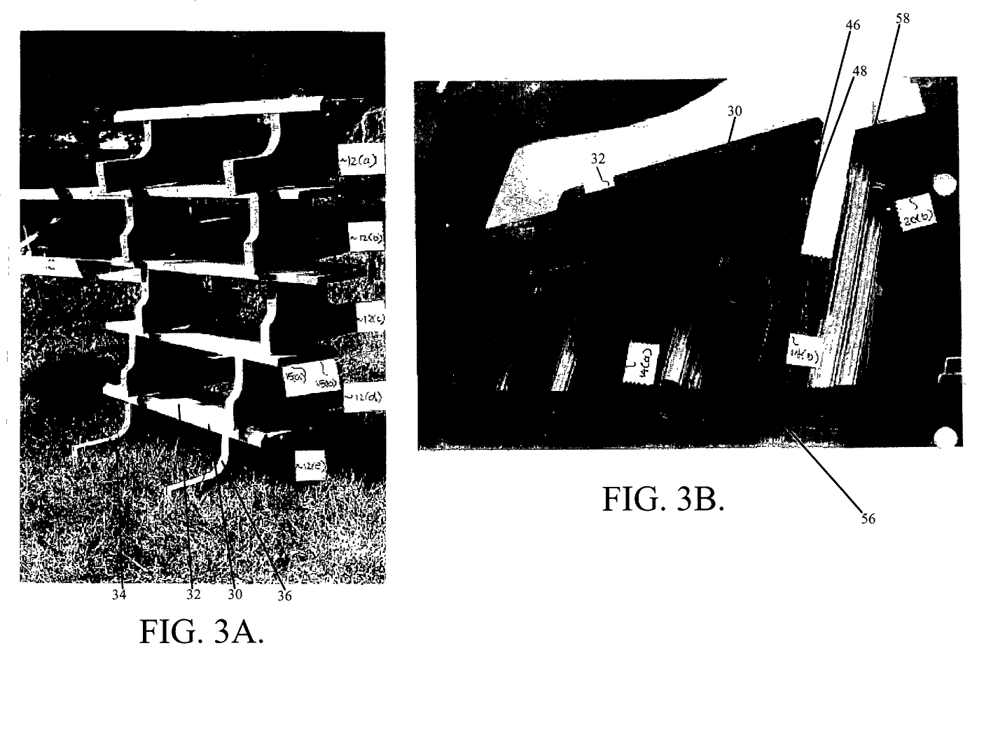

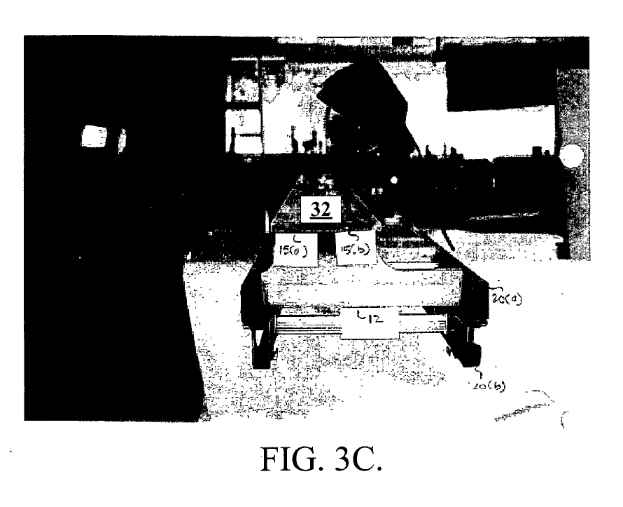

As shown in FIGS. 3A-C, the component parts 12(a-e) are preferably made of wood, however other materials can be used such as plexi-glass, composites, metals or metal alloys, fiberglass, polymer based material, including any plastics, or ceramics are considered within the scope of this invention.

As shown in FIG. 3A, a section part 30 includes a surface piece 32 attached to a pair of support legs 34 and 36. The surface piece 32 is suitably nailed to the support legs 34 and 36. However, the surface piece 32 can be sealed or bonded on top of the support legs 34 and 36 or secured by screws or some other securing mechanism. The legs 34 and 36 of each component part fits inside the ladder 20. Attaching all component parts 12(a-e) forms both halves of the portable table 10.

In another embodiment as shown in FIG. 3B, a pair of dowels 46 and 48 are attached to one end of the surface piece 32 of the section part 30, while located at the opposite end of the surface piece 32 is a pair of dowel holes (not shown) for receiving dowels 46 and 48 from an adjacent component part (shown in FIGS. 3A and 3C). The support legs 14a and 14b are shown located between a first rail 56 and a second rail 58 of the outer section 20a of the ladder 20.

The preferred embodiment using an extension ladder is shown in FIG. 3C, however, other extension ladders similar to the one illustrated can also be used. Dowels 15a and 15b are shown in relationship to the surface pierce 32. The component part 12 is shown in relationship to the inner and outer sections 20a and 20b of the ladder 20.

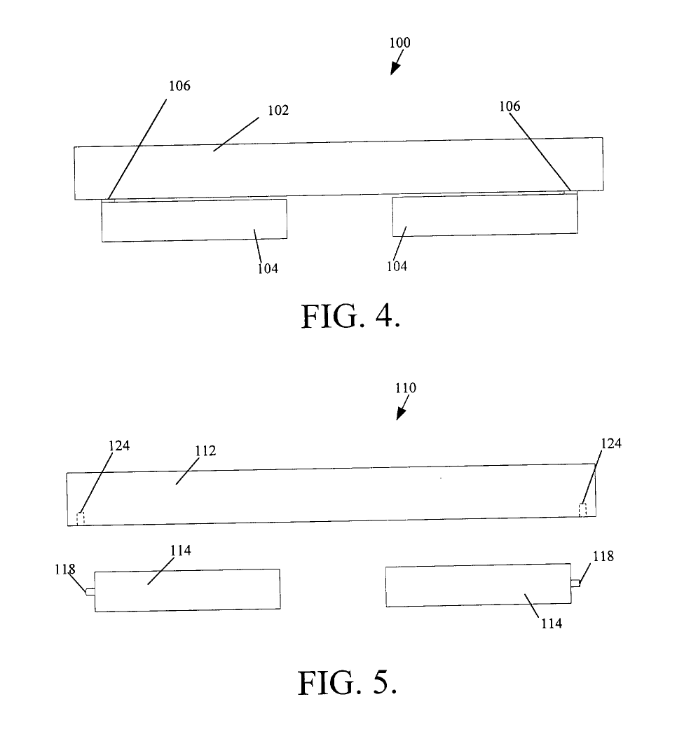

FIGS. 4 and 5 illustrate other ways to secure the surface piece 32 to the legs 34 and 36. FIG. 4 illustrates an alternate embodiment that allows a component part 100 to be folded for ease in storage and transportation. The component part 100 includes a top surface 102 connected to two legs 104 by respective hinges 106. The hinges 106 are attached to allow the legs 104 to rotate from a position parallel with the top surface 102 to a use position that is about 90 degrees from the parallel position. As can be appreciated by one of ordinary skill in the art, other types of hinging mechanisms can be used in order to allow the legs 104 to be folded to a use position and a storage position.

FIG. 5 illustrates to another embodiment that allows a component part 110 to be easily stored for transportation. The component part 110 includes a top surface 112 and two legs 114. At a first end of each of the legs 114 is a pin or dowel device 118. The top surface 112 includes pin or dowel receiving cavities 124 at opposing ends of the top surface 112. When the pin 118 of the legs 114 are inserted into the cavities 124, the component part 110 is ready for use. As can be readily appreciated by one of ordinary skill in the art, other types of connection devices can be used to allow the legs 114 to be easily disassembled and packed for storage and transportation.

While the preferred embodiment of the invention has been illustrated and described, as noted above, many changes can be made without departing from the spirit and scope of the invention. For example, the tool piece can be located anywhere relative to the table, including being located on an end of the portable table. Also, any number of table sections can be used to make a table of infinite length. Additionally, the table surface may be wider or narrower and of any length. Also, any table section connection structure is considered within the scope of this invention, for example, clips, snaps, buckles, straps, dovetail, tongue-and-groove, ship-lap, magnetic connectors and any other common or uncommon connecting structure. Accordingly, the scope of the invention is not limited by the disclosure of the preferred embodiment. Instead, the invention should be determined entirely by reference to the claims.

The embodiments of the invention in which an exclusive property or privilege is claimed are defined as follows:

1. A table device comprising:
a plurality of table components, each component comprising:
a table surface piece; and
at least two legs, wherein each of the legs are configured to be received by side rails of a ladder.

2. The device of claim 1, wherein the legs are hingedly attached to the table surface piece.

3. The device of claim 1, further comprising a pin connection device for coupling the legs to the top surface.

4. A portable table comprising:
a ladder; and
one or more table components, wherein the one or more table components include:
a table surface piece; and
at least two legs coupled to the table surface piece, wherein the legs are configured to be received by the ladder.

5. The table of claim 4, further comprising at least two ladder support structures.

6. The table of claim 4, wherein the legs are hingedly attached to the table surface piece.

7. The table of claim 4, further comprising a pin connection device for coupling the legs to the top surface.
